(19) United States
(12) Patent Application Publication
(10) Pub. No.: US 2013/0140787 A1
(43) Pub. Date: Jun. 6, 2013

(54) SLIDER

(71) Applicant: Young Seung Ko, Incheon (KR)

(72) Inventor: Young Seung Ko, Incheon (KR)

(21) Appl. No.: 13/810,958

(22) PCT Filed: Apr. 11, 2011
(86) PCT No.: PCT/KR11/03032

§ 371 Date: Jan. 18, 2013

(30) Foreign Application Priority Data
Apr. 26, 2010 (KR) 10-2010-0038711
Jul. 23, 2010 (KR) 10-2010-0071653
Oct. 19, 2010 (KR) 10-2010-0102166

(51) Int. Cl. B62M 1/18; B62K 3/00

(52) U.S. Cl. CPC B62M 1/18; B62K 3/002
USPC 280/221

(57) ABSTRACT

A slider is provided which can travel ahead by placing a user's foot on a board and stamping the ground with the other foot like a known kick board or which can exercise a user by causing shafts each having a rear board fixed thereto to sufficiently extend backward and moving the shafts at symmetric angles relative to each other and can spontaneously travel ahead by means of waveform-like actions using rear casters attached to the bottoms of the rear boards.

### BACKGROUND OF THE INVENTION

1. Technical Field

The present invention relates to a slider, and more particularly, to a slider which can travel ahead by placing a user's foot on a board and stamping the ground with the other food like a known kick board or which can exercise a user by causing shafts each having a rear board fixed thereto to sufficiently extend backward and moving the shafts at symmetric angles and can spontaneously travel ahead by means of waveform-like motions using rear casters attached to the bottoms of the rear boards.

2. Background Art

In general, boards basically travel ahead by stamping the ground with a foot, which is not sufficient for enjoying a high speed and thrill.

In-line stakes travel ahead by moving feet backwardly or laterally while maintaining a body's balance. However, the in-line skates have a problem in that they can provide the high speed and the thrill, but can also provide a risk to fall because a user has to maintain the body balance while moving both feet.

Since the in-line skates travel ahead while a user moves only both feet, they are not sufficient for the effect of exercise of the whole body.

An instrument traveling ahead by moving a handlebar and moving the feet like skiing has been developed to solve the problems of the in-line skates or boards. However, such an instrument can provide a user with safety and flexibility, but is not sufficient for thrill.

Since the in-line skates are not provided with a braking system for controlling the traveling speed, a user riding an in-line skate had to reduce the speed by stepping one foot on the ground. Accordingly, it was not possible to rapidly and safely cope with unexpected situations during traveling, thereby causing a safety accident.

A so-called “kick board” having a handlebar and casters on the front and back sides of a board has been developed. The kick board can travel ahead by kicking the ground with a foot with the other foot placed on a board.

### SUMMARY OF THE INVENTION

### Technical Problem

An advantage of some aspects of the invention is that it provides a slider which can travel ahead by causing a user to slide two rear boards backwardly as needed, causing the user to place both feet on the rear boards, respectively, and causing the user to repeat leg folding and unfolding actions.

### Solution to Problem

According to an aspect of the invention, there is provided a slider in which rear boards which are disposed on the rear side of the slider and on which a user's feet are placed slide along a guide shaft.

In the slider, the sliding length of the rear boards may be controlled by a slide stopper disposed in the slider.

In the slider, the slide stopper may control the sliding length of the rear boards by multi-steps.

In the slider, a torsion spring may be disposed to give a folding elastic force when the rear boards are unfolded from each other.

According to another aspect of the invention, there is provided a slider including a steering unit causing a user to change a direction with hands, wherein the steering unit does not move when a connector portion of the steering unit to a slider body comes in contact with a shaft having a polygonal section.

### Advantageous Effect

The slider according to the above-mentioned aspects of the invention can be used like the known kick board and can also travel ahead by causing both shafts having the rear boards disposed thereon to slide and folding and unfolding both rear boards with both feet placed on both rear boards.

Since the shafts with the rear boards disposed thereon can slide by multi-steps by the slide stopper, a child with short legs can conveniently ride the slider. Since the steering unit can be easily folded by the hinge structure including the connector portion and the steering support, a user can conveniently carry and store the slider. Since a leaf spring is disposed in the front of the shaft hinge and the slide hinge, the unfolded rear boards can be easily folded with the elastic force of the leaf spring.

### BRIEF DESCRIPTION OF THE DRAWINGS

FIG. 1 is a perspective view illustrating a slider according to an embodiment of the invention.

FIG. 2 is a perspective view illustrating the slider where a front board is removed from the slider shown in FIG. 1.

FIG. 3 is a perspective view illustrating a state where a slide hinge of the slider slides in the longitudinal direction as much as possible and both shafts and both rear boards are unfolded.

FIG. 4 is a perspective view illustrating a state where a slide hinge of the slider slides in the longitudinal direction as much as possible and both shafts and both rear boards are unfolded and where a front board is removed from the state shown in FIG. 3.

FIG. 5 is an exploded perspective view illustrating a slide hinge of the slider according to the embodiment of the invention.

FIG. 6 is an exploded perspective view illustrating a slider according to another embodiment of the invention.

FIGS. 7A and 7B are diagrams illustrating the hinge structure of a connector portion connected to a steering support of the slider.

FIGS. 8A and 8B are diagrams illustrating a state where the steering support and the connector portion are locked to each other.

FIGS. 9A and 9B are diagrams illustrating a state where the steering support and the connector portion are opened from each other.

FIGS. 10A to 10E are diagrams illustrating the configuration and the operational principle of a slide stopper according to the embodiment of the invention.

FIGS. 11A and 11B are a perspective view and an exploded perspective view illustrating a sliding unit of the slider according to the embodiment of the invention, respectively.

FIG. 12 is a perspective view illustrating a slider according to another embodiment of the invention

FIG. 13 is a perspective view illustrating a state where the sliding unit of the slider slides and both shafts are unfolded.

FIG. 14 is a perspective view illustrating a state where the steering unit of the slider is folded.

FIG. 15 is a diagram illustrating a slider according to a modified example of the invention where a torsion spring is used instead of the leaf spring in the slider shown in FIG. 11.

### DESCRIPTION OF EXEMPLARY EMBODIMENTS

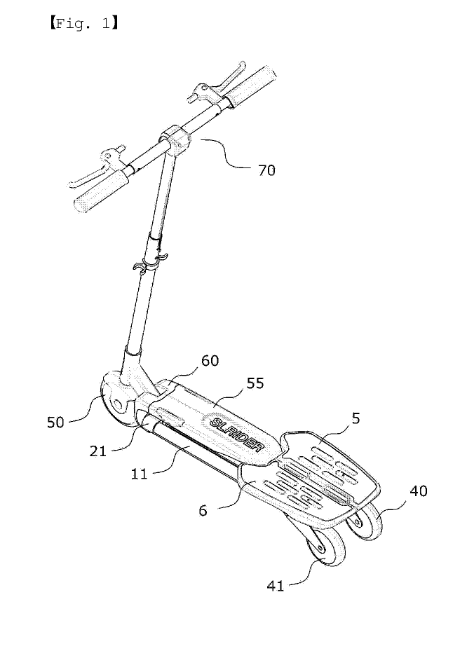

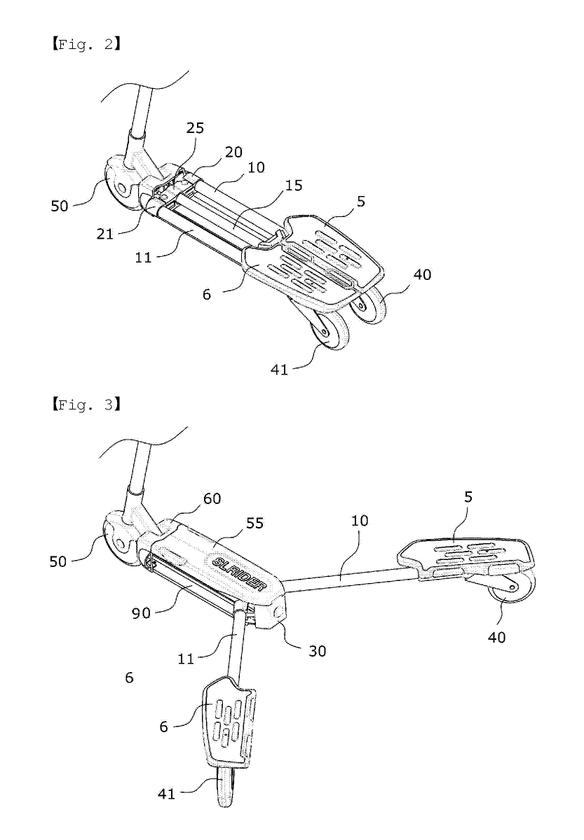

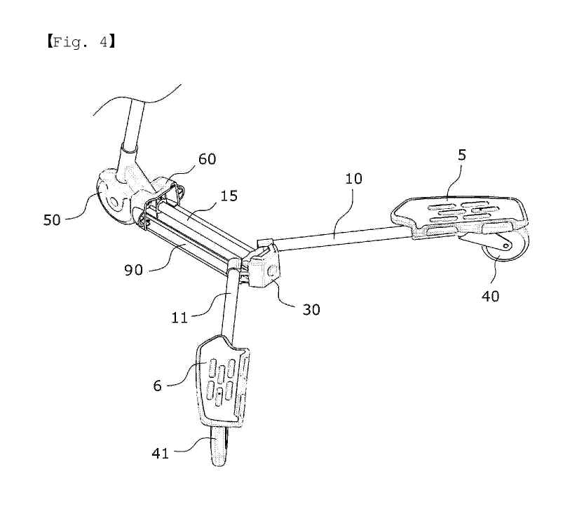

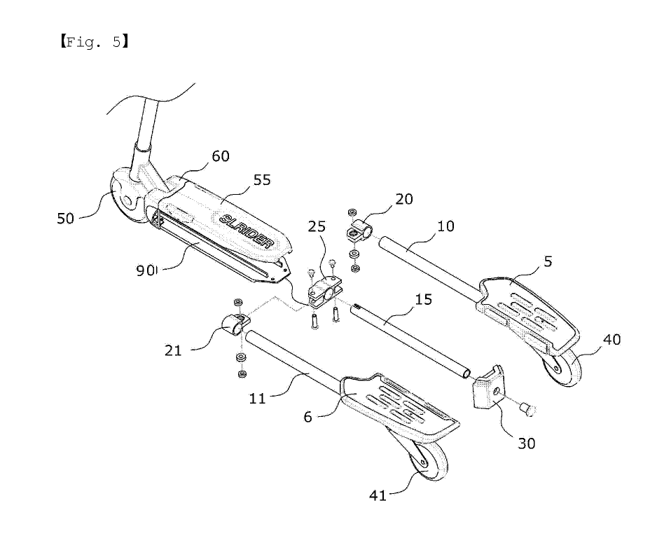

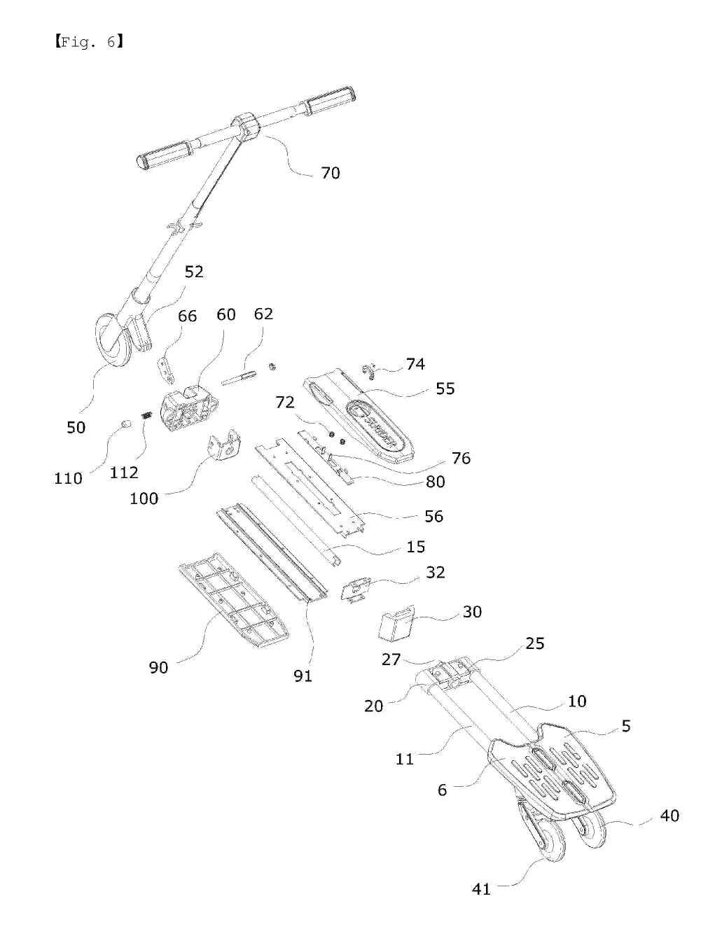

FIG. 1 is a perspective view illustrating a slider according to an embodiment of the invention. FIG. 2 is a perspective view illustrating the slider where a front board is removed from the slider shown in FIG. 1. FIG. 3 is a perspective view illustrating a state where a slide hinge of the slider slides in the longitudinal direction as much as possible and both shafts and both rear boards are unfolded. FIG. 4 is a perspective view illustrating a state where a slide hinge of the slider slides in the longitudinal direction as much as possible and both shafts and both rear boards are unfolded and where a front board is removed from the state shown in FIG. 3. FIG. 5 is an exploded perspective view illustrating a slide hinge of the slider according to the embodiment of the invention.

Referring to FIG. 5, a slider according to an embodiment of the invention includes a steering support 60 coupled to a support plate 90, a guide shaft 15 fixedly coupled to the steering support 60, a slide hinge 25 into which the guide shaft 15 is inserted in the state where the guide shaft 15 is fixed coupled to the steering support 60 and which slides longitudinally, right and left shaft hinges 20 and 21 which are rotatably coupled to the slide hinge 25, and right and left shafts 10 and 11 fixedly coupled to the shaft hinges 20 and 21. The front part of the steering support 60 is coupled to a steering unit 70 below which a steering wheel is disposed.

Ends of the right and left shafts 10 and 11 are provided with rear boards 5 and 6, respectively, on which a user's feet are placed. Casters 41 inclined at a predetermined angle and serving as rear wheels are disposed on the bottom surfaces of the rear boards 5 and 6.

After the guide shaft 15 and the slide hinge 25 are assembled, a cover 30 is disposed at an end of the guide shaft 15 so as to prevent the slide hinge 25 from dropping from the guide shaft 15.

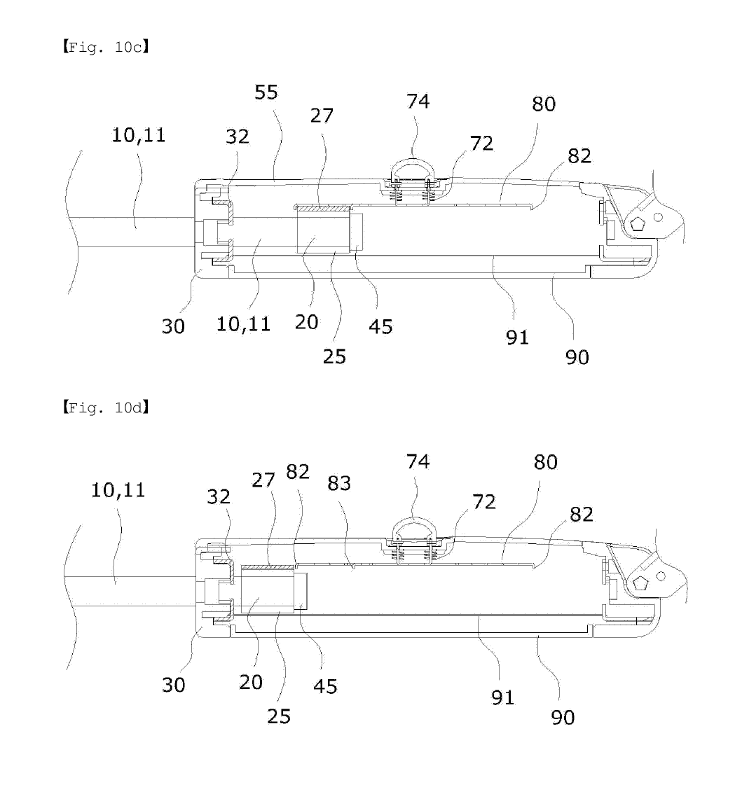

Referring to FIG. 1, in the state where the slide hinge 25 has not slide along the guide shaft 15, the shaft hinges 20 and 21 disposed in the front of the right and left shafts 10 and 11 come in close contact with the flat plane of the steering support 60 so as not to be unfolded laterally and are fixed by a locking system locking the slide hinge 25 so as to cause the rear boards 5 and 6 not to slide backwardly (see FIGS. 10A to 10E).

In the state shown in FIG. 1, a user can use the slider like the known kick board by kicking the ground with a foot in a state where the other foot is placed on a front board 55 or the rear boards 5 and 6.

Referring to FIG. 2, since the guide shaft 15 has a circular section and the slide hinge 25 inserted into the guide shaft 15 has a circular section, the steering unit 70 can be shaken to be oblique laterally in a state where the user places the feet on the rear boards 5 and 6. This can allow the user to change the direction of the traveling slider or to obtain a greater driving force.

Referring to FIGS. 3 and 4, when the locking system is unlocked and the rear boards 5 and 6 are pulled out, the slide hinge 25 slides backwardly along the guide shaft 15 and the shafts 10 and 11 connected to the slide hinge 25 also slide backwardly, whereby the shafts can be unfolded and folded about both ends of the slide hinge 25.

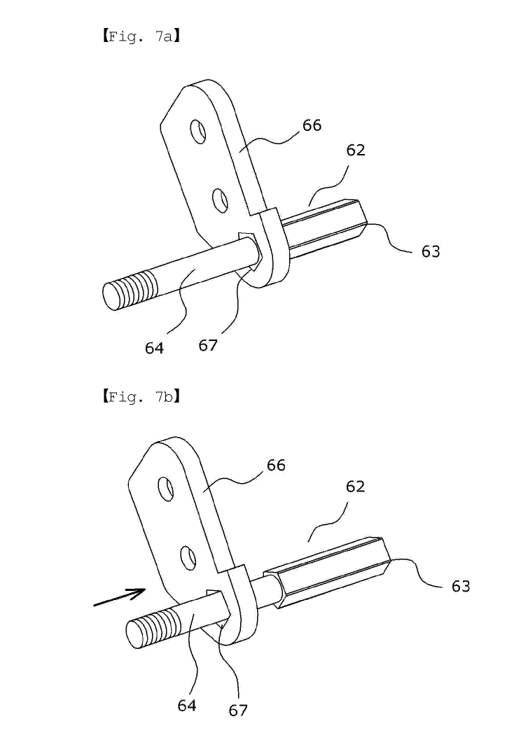

FIGS. 6 to 15 show a slider according to another embodiment of the invention, which will be described in detail below.

FIG. 6 is an exploded perspective view illustrating a slider according to another embodiment of the invention as a whole.

Referring to FIG. 6, in the slider according to another embodiment of the invention, a support plate 90 and an auxiliary support plate 91 corresponding to the bottom are fixedly coupled to the steering support 60. The guide shaft 15 is inserted into the rear portion of the steering support 60 in the state where a front fixing member 100 is coupled thereto, the front fixing member 100 is coupled to the steering support 60 with a screw or the like, and the guide shaft 15 is inserted into an opened hole of the front fixing member 100. In the state where the guide shaft 15 is fixedly coupled to the steering support 60, the guide shaft 15 is inserted into the slide hinge 25 so as to slide in a longitudinal direction, the right and left hinges 20 and 21 are rotatably coupled to the slide hinge 25, and the right and left shafts 10 and 11 are coupled to the shaft hinges 20 and 21. The rear boards 5 and 6 on which a user's feet are placed are disposed at ends of the right and left shafts 10 and 11 and casters 40 and 41 inclined at a predetermined angle and serving as rear wheels are disposed on the bottom surfaces of the rear boards 5 and 6.

After the guide shaft 15 is inserted and assembled into the slide hinge 25, a cover 30 in which a rear fixing member 32 is disposed is coupled to the rear part of the guide shaft 15 and the cover 30 and the rear fixing member 32 are fixedly coupled to the guide shaft 15 with a screw (not shown) or the like so as to prevent the slide hinge 25 from dropping from the guide shaft 15.

A hinge unit is disposed in the front of the steering support 60 so as to be folded with respect to the steering unit 70 having a steering wheel 50 disposed in the front thereof.

A metal connection plate 66 is inserted into the connector portion 52 protruding from the lower part of the steering unit 70 and a connection shaft 62 is inserted into the steering support 60, the connector portion 52, and the connection plate 66 in the state where the connector portion 52 into which the connection plate 66 is inserted is inserted into a concave portion of the steering support 60. A spring 112 is inserted onto the connection shaft 62 on the opposite side of the side into which the connection shaft 62 is inserted and a cover 110 is screwed to the end of the connection shaft 62 so as to prevent the spring 112 from dropping therefrom.

A slide stopper 80 controlling the sliding of the slide hinge 25 in the state where it is inserted into the guide shaft 15 is disposed under the front board 55. The slide stopper 80 is inserted into a center opening of a reinforcing plate 56 coupled to the steering support 60 and the hinge stopper 27 is hooked on a center protrusion of the slide hinge 25, thereby regulating the sliding of the slide hinge 20 along the guide shaft 15.

A rubber member may be disposed on the bottom surface of the shaft hinges 20 and 21. This improves the elastic force at the time of laterally shaking the steering unit 70.

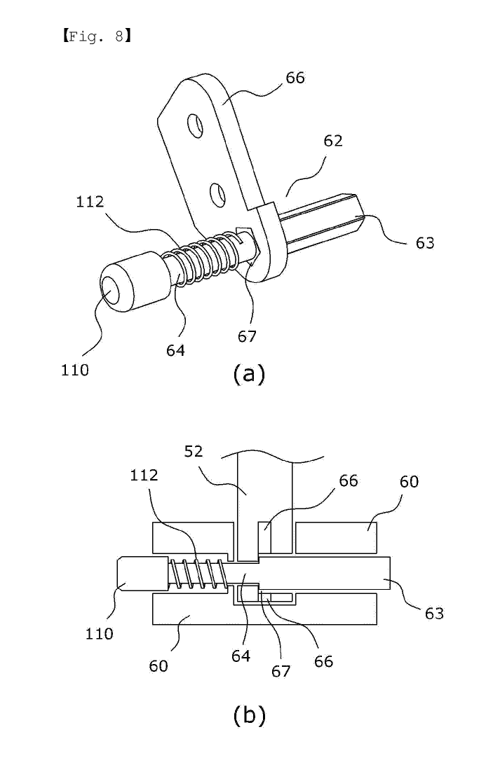

FIGS. 7A and 7B are diagrams illustrating the hinge structure of the connector portion coupled to the steering support.

Referring to FIG. 7A, the connection shaft 62 includes a cylindrical portion 64 having a circular section and a polygonal pillar portion 63 having a polygonal section such as a tetragon and a pentagon. A polygonal opening 67 having the same sectional shape as the section of the polygonal pillar portion 63 into which the connection shaft 62 is inserted.

In the drawing, a state where the polygonal pillar portion 63 engages with the polygonal opening 67 is shown. In this state, the connection plate 66 is fixed to the connection shaft 63 so as not to move.

Referring to FIG. 7B, the connection shaft 62 moves to the right which is the direction of the arrow and the cylindrical portion 64 is located in the polygonal opening 67. In this case, the connection plate 66 can rotate about the connection shaft 62. Accordingly, the steering unit 70 coupled to the connection plate 66 can rotate and the upper part of the steering unit 70 can be folded to the front board 55.

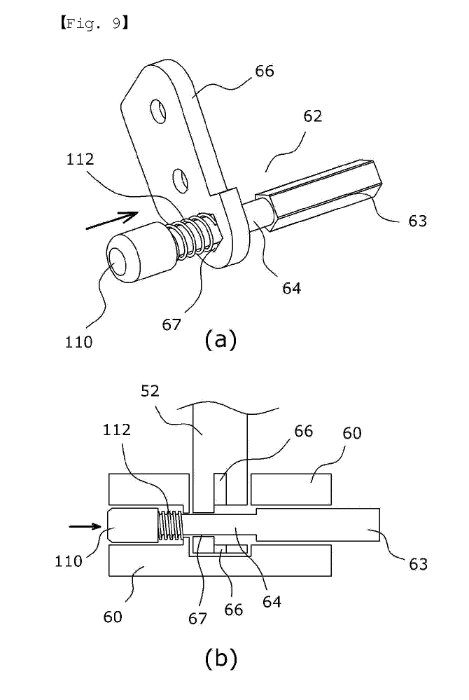

FIGS. 8A and 8B are diagrams illustrating a state where the steering support and the connector portion are locked to each other.

Referring to FIGS. 8A and 8B, the connection shaft 62 inserted through the steering support 60 and the polygonal opening 67 of the connection plate 66 includes a spring 112 and a cap 110 screwed to the end of the connection shaft 62. When an external force is not applied to the cap 110, the polygonal pillar portion 63 engages with the polygonal opening 67 with the elastic force of the spring 112 so as not to move. Accordingly, the steering unit 70 maintains a state where it is locked to the steering support 60 so as not to rotate.

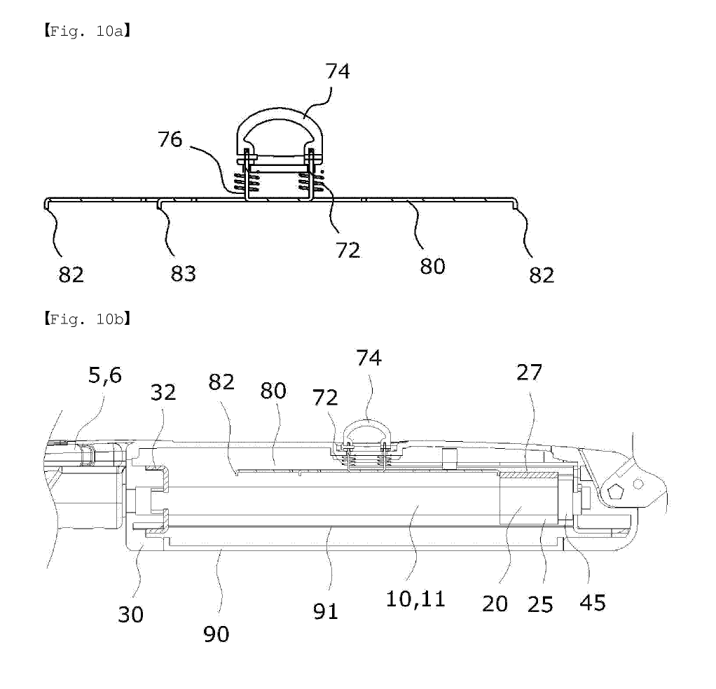

FIGS. 9A and 9B are diagrams illustrating a state where the steering support and the connector portion are unlocked from each other.

Referring to FIGS. 9A and 9B, when the cap 110 is pressed in the direction of the arrow with a user's finger, the polygonal pillar portion 63 of the connection shaft 62 is separated from the polygonal opening 67 of the connection plate 66. Accordingly, the connection plate 66 can rotate about the connection shaft 62.

When the user intends to fold the steering unit 70, the polygonal opening 67 is disengaged from the polygonal pillar portion 63 by pressing the cap 110 and the steering unit 70 can rotate about the steering support 60.

FIGS. 10A to 10E are diagrams illustrating the configuration and the operational principle of the slide stopper according to the embodiment of the invention.

Referring to FIG. 10A, the slide stopper 80 includes three stop points 82 and 83 of both ends and a portion bent downward from a part located close to the left end thereof.

A knob 74 used for a user to lift up the slide stopper 80 with a finger are connected to the slide stopper 80 with two supports 76 interposed therebetween. A coil spring 72 is inserted onto each support 76. Accordingly, when the user does not pull the knob 74 upwardly, the stopper 80 is urged to the downside with the elastic force of the coil springs 72 and comes in contact with the hinge stopper 27 of the slide hinge 25 so that the slide hinge 25 does not slide.

Referring to FIG. 10B, the slide hinge 25 and the shafts 10 and 11 coupled thereto do not slide along the guide shaft since they come in contact with the rear surface of the steering support 60. The stop point 82 at the right end of the slide stopper 80 comes in contact with the hinge stopper 27 so as to prevent the slide hinge 25 and the shafts 10 and 11 coupled thereto from sliding to the left.

The stopper 80 is urged downwardly with the spring 72 inserted onto the supports 76 when an external force is not applied thereto.

Referring to FIG. 10C, the shafts 10 and 11 and the slide hinge 25 slide and the hinge stopper 27 is stopped between the stop points 82 and 83 located on the left side of the slide stopper 80.

When the user of the slider is a child with short legs, the child can also conveniently use the slider by hooking the hinge stopper 27 between the stop points 82 and 83 under the middle part without causing the entire shafts 10 and 11 to slide out as shown in FIG. 10C. In a modified example, one or more stop points 83 can be disposed inside the slide stopper 80 to embody a multi-step sliding stopper.

Referring to FIG. 10D, the shafts 10 and 11 and the slide hinge 25 slide to the left side as a whole and the hinge stopper 27 comes in contact with the stop point 82 located at the left end of the slide stopper 80 so as not to move.

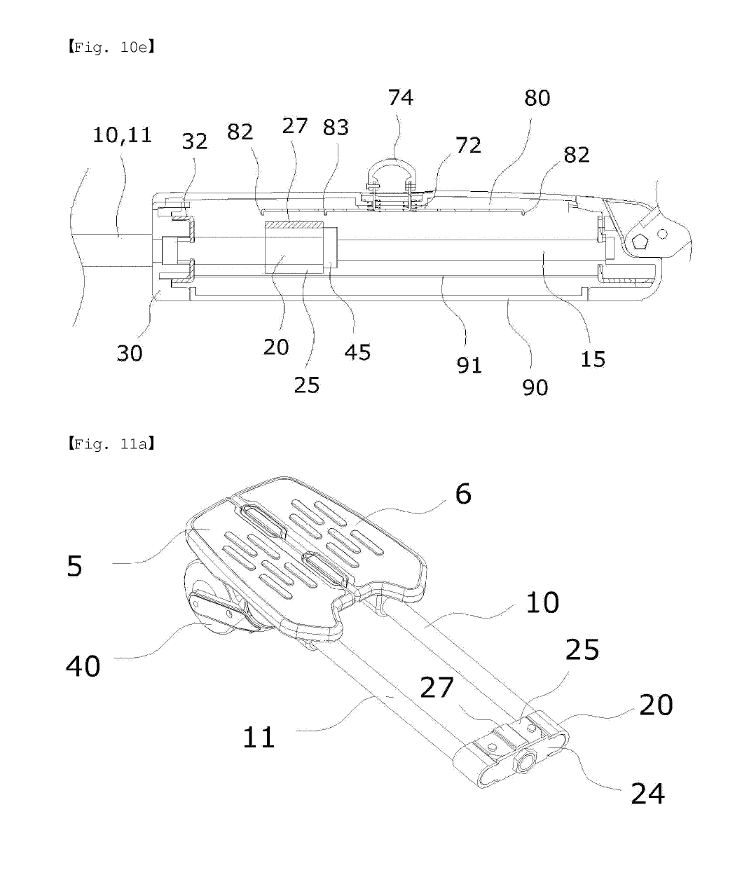

In the drawing, it seems that there is a room between the rear fixing member 32 and the shaft hinge 20, but a gap is not actually generated due to a bolt 46 shown in FIG. 11B.

Referring to FIG. 10E, the user pulls up the knob 74 of the slide stopper 80, whereby the slide stopper 80 is lifted up and thus the stop points 82 and 83 are separated upward from the hinge stopper 27.

FIGS. 11A and 11B are a perspective view and an exploded perspective view illustrating a sliding unit of the slider according to the embodiment of the invention.

Referring to FIG. 11A, a completely-assembled sliding unit of the slider is shown.

A leaf spring 24 is attached to the front part of the slide hinge 25 and the shaft hinges 20 and 21 rotatably coupled thereto. When a user unfolds the shafts 10 and 11 outwardly, the unfolded shafts 10 and 11 can be easily folded by the restoring force of the leaf spring 24, which is convenient to the user.

FIG. 11B is an exploded perspective view illustrating the sliding section of the slider according to the embodiment of the invention. The shaft hinges 20 and 21 coupled to the shafts 10 and 11 are rotatably coupled to both side surfaces of the slide hinge 25 by the use of rivets 47 or the like. A bolt portion 46 in which a through-hole is formed so as to pass the guide shaft 15 is inserted into a through-hole of the slide hinge 25. The leaf spring 24 is attached so as to cover the front surfaces of the shaft hinges 20 and 21 and the slide hinge 25 and a nut portion 45 of which the center is opened so as to pass the guide shaft 15 is coupled to the bolt portion 46, whereby the assembly is completed.

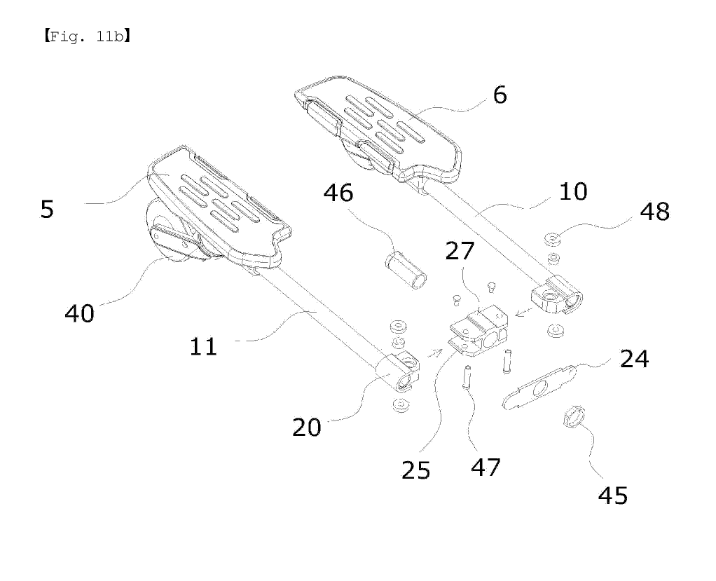

FIG. 12 is a perspective view illustrating a slider according to another embodiment of the invention.

Referring to FIG. 12, in a state where the slide hinge 25 does not slide along the guide shaft 15, the front parts of the right and left shafts 10 and 11 come in contact with a flat protrusion on the side surface of the steering support 60 and are not unfolded laterally, and the slide hinge 25 is locked with the slide stopper 80. In this state, the slider can be used like the known kick board.

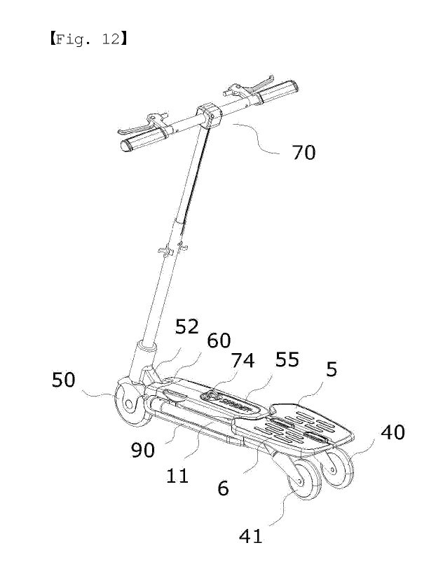

FIG. 13 is a perspective view illustrating a state where the sliding section of the slider according to the embodiment of the invention slides and the shafts are unfolded laterally.

Referring to FIG. 13, when a user pulls the knob 74 and lifts the slide stopper 80, the locking of the hinge stopper 27 is unlocked. In this state, when the rear boards 5 and 6 are pulled up, the slide hinge 25 slides backwardly along the guide shaft 15 and the shafts 10 and 11 coupled to the slide hinge 25 slide backwardly, whereby the rear boards 5 and 6 can be unfolded laterally.

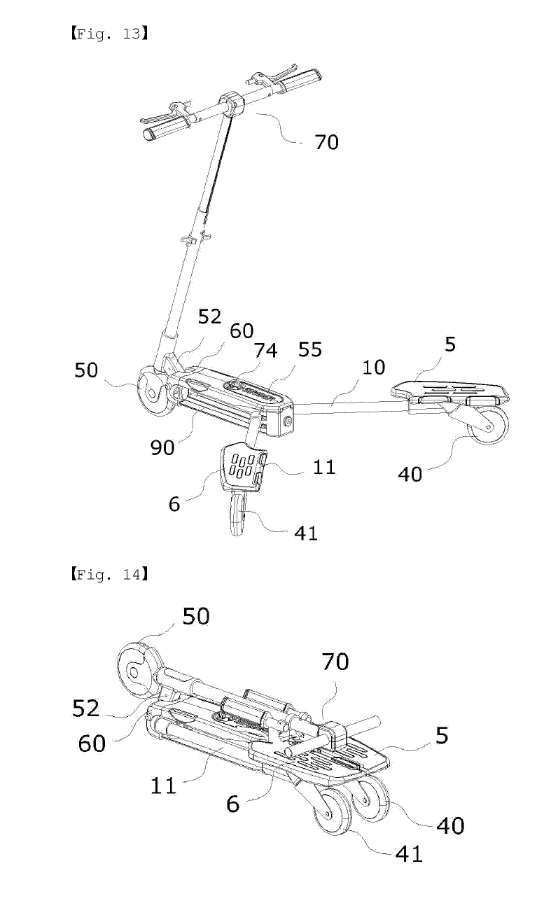

FIG. 14 is a perspective view illustrating a state where the steering unit of the slider according to the embodiment of the invention is folded.

Referring to FIG. 14, when a user presses the cap 110 of the connection shaft 62 toward the inside of the steering support 60 with a finger, the locking of the steering unit 70 is unlocked and the user can fold the steering unit 70 as shown in the drawing. When the user stops pressing the cap 110, the steering unit 70 is locked to the steering support 60 in the state where it is folded.

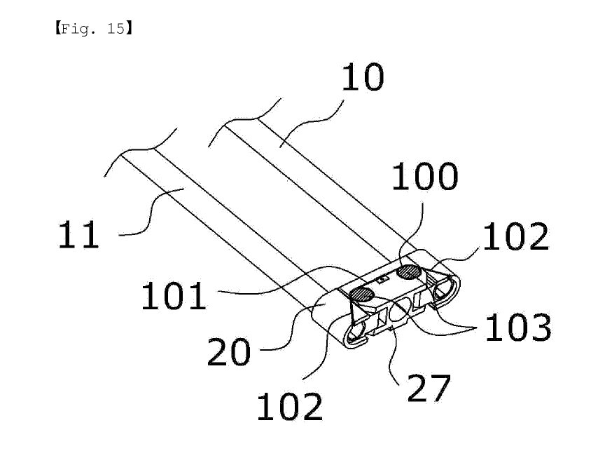

FIG. 15 is a diagram illustrating a modification where a torsion spring is attached instead of the leaf spring in the perspective view of the sliding section shown in FIGS. 11A and 11B.

Referring to FIG. 15, two torsion springs 100 instead of the leaf spring 24 are attached to the front parts of the slide hinge 25 and the shaft hinges 20 and 21 rotatably coupled thereto. When the user unfolds the legs to unfold the shafts 10 and 11 laterally, the unfolded shafts 10 and 11 are urged to be folded with the restoring force of the torsion springs 100, which is convenient to the user.

Inner arms 101 of two torsion springs 100 are coupled to the slide hinge 25 and outer arms 102 of two torsion springs 100 are fixedly coupled to the shaft hinges 20 and 21 coupled to the shafts 10 and 11, respectively.

Since the torsion springs 100 are hooked on two protrusions 103 having a circular section and protruding from the slide hinge 25, respectively, the torsion springs 100 are fixed onto and supported by the slide hinge 25 at the time of action.

The guide shaft 15 of the slider according to the embodiments of the invention may have a tetragonal section. In this case, the bolt portion 46 through which the guide shaft 15 is inserted has a tetragonal opening. Alternatively, when a particular bolt portion 46 is not provided, the through-hole of the slide hinge 25 may have a tetragonal section.

While the embodiments of the invention have been described, the invention is not limited to the embodiments, but may be modified in various forms without departing from the spirit and the scope of the appended claims.

1. A slider in which rear boards which are disposed on the rear side of the slider and on which a user's feet are placed slide along a guide shaft.

2. The slider according to claim 1, wherein the sliding length of the rear boards is controlled by a slide stopper disposed in the slider.

3. The slider according to claim 2, wherein the slide stopper controls the sliding length of the rear boards by multi-steps.

4. The slider according to claim 1, wherein a torsion spring is disposed to give a folding elastic force when the rear boards are unfolded from each other.

5. A slider comprising a steering unit causing a user to change a direction with hands,
wherein the steering unit does not move when a connector portion of the steering unit to a slider body comes in contact with a shaft having a polygonal section.
